(19) United States
(12) Patent Application Publication
(10) Pub. No.: US 2026/0299099 A1
(43) Pub. Date: Oct. 1, 2026

(54) IMAGING DEVICE

(71) Applicant: SK hynix Inc., Icheon-si (KR)

(72) Inventors: Ji Hee HAN, Icheon-si (KR); Ju Hyun CHO, Icheon-si (KR)

(21) Appl. No.: 19/294,182

(22) Filed: Aug. 7, 2025

(30) Foreign Application Priority Data
Mar. 26, 2025 (KR) 10-2025-0038974

(51) Int. Cl. G01S 7/486; G01S 7/481; G01S 7/4863; G01S 7/4865; G01S 17/89

(52) U.S. Cl. CPC G01S 7/4868; G01S 7/4816; G01S 7/4863; G01S 7/4866; G01S 17/89

(57) ABSTRACT

An imaging device including a sensor capable of detecting a distance to a target object based on a time-of-flight (TOF) method is disclosed. In an embodiment, an image device comprise: an image signal processor which includes: an analyzer configured to: generate an intensity image of an object to be imaged by an image sensor based on a count value representing a number of detection events obtained by sensing reflected light from the object and detecting photons of the reflected light; analyze a change in an intensity value of the intensity image over a first time period; and analyze a change in a temperature over the first time period; and an intensity attenuation determiner configured to determine an occurrence of intensity attenuation in the intensity image over time based on an analysis result of the analyzer.

### PRIORITY CLAIM AND CROSS-REFERENCE TO RELATED APPLICATION

This patent document claims the priority and benefits of Korean patent application No. 10-2025-0038974, filed on Mar. 26, 2025, the disclosure of which is incorporated by reference in its entirety as part of the disclosure of this patent document.

### TECHNICAL FIELD

The technology and implementations disclosed in this patent document generally relate to an imaging device including a sensor capable of detecting a distance to a target object based on a time-of-flight (TOF) method.

### BACKGROUND

An image sensing device can capture optical images by converting light into electrical signals using a photosensitive semiconductor material that reacts to light. With advancements in industries such as automotive, medical, computer and communication industries, the demand for high-performance image sensing devices is growing across various fields such as smartphones, digital cameras, game machines, IoT (Internet of Things), robots, security cameras and medical micro cameras.

The image sensing device may be used to acquire a color image or a depth image of a scene. Recently, a TOF (time-of-flight) method has been employed to capture a depth image of a scene by measuring the time it takes for light (e.g., infrared light) emitted by a light source to be reflected from a target object and return to a sensor. This measurement enables the calculation of the distance to the target object.

### SUMMARY

Various embodiments of the disclosed technology relate to an image signal processor capable of determining occurrence or non-occurrence of intensity attenuation in an intensity image acquired through reflected light.

In an embodiment of the disclosed technology, an imaging device, comprise: an image signal processor which includes: an analyzer configured to: generate an intensity image of an object to be imaged by an image sensor based on a count value representing a number of detection events obtained by sensing reflected light from the object and detecting photons of the reflected light; analyze a change in an intensity value of the intensity image over a first time period; and analyze a change in a temperature over the first time period; and an intensity attenuation determiner configured to determine an occurrence of intensity attenuation in the intensity image over time based on an analysis result of the analyzer.

In another embodiment of the disclosed technology, an imaging device may include: a light source module configured to emit modulated light toward a target object; a time-of-flight (TOF) sensor including a pixel configured to generate pixel data in response to detecting reflected light reflected from the target object; a temperature sensor configured to generate a temperature value corresponding to a temperature of the time-of-flight (TOF) sensor; and an image signal processor configured to: generate an intensity image based on a count value representing a number of detection events the pixel detects photons of the reflected light; analyze a change in an intensity value of the intensity image over a first time period; analyze a change in the temperature value over the first time period; and determine an occurrence of intensity attenuation of the pixel.

It is to be understood that both the foregoing general description and the following detailed description of the disclosed technology are illustrative and descriptive and are intended to provide further description of the embodiments of the disclosed technology as claimed.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a block diagram illustrating an example of an imaging device based on some embodiments of the disclosed technology.

FIG. 2 is a block diagram illustrating a time-of-flight (TOF) sensor shown in FIG. 1 based on some embodiments of the disclosed technology.

FIG. 3 is a schematic diagram illustrating an example of a macropixel included in the time-of-flight (TOF) sensor shown in FIG. 2 based on some embodiments of the disclosed technology.

FIG. 4 is a circuit diagram illustrating an example of a pixel shown in FIG. 3 based on some embodiments of the disclosed technology.

FIG. 5 is a block diagram illustrating an example of an image signal processor shown in FIG. 1 based on some embodiments of the disclosed technology.

FIG. 6 is a flowchart illustrating example operations of the image signal processor shown in FIG. 5 based on some embodiments of the disclosed technology.

FIGS. 7A and 7B are diagrams illustrating example graphs showing changes in intensity values and temperatures based on some embodiments of the disclosed technology.

FIGS. 8A and 8B are diagrams illustrating example graphs showing changes in intensity values and temperatures based on other embodiments of the disclosed technology.

FIG. 9 is a block diagram illustrating an example of a computing device corresponding to the image signal processor of FIG. 1 based on some embodiments of the disclosed technology.

### DETAILED DESCRIPTION

This patent document provides implementations and examples of an imaging device that can detect a distance to a target object based on a time-of-flight (TOF) method that may be used in configurations to substantially address one or more technical or engineering issues and to mitigate limitations or disadvantages encountered in some imaging devices in the art. Some implementations of the disclosed technology relate to an image signal processor that can determine the occurrence or non-occurrence of intensity attenuation in an intensity image acquired from reflected light. In recognition of the issues above, the image signal processor and the imaging device including the same based on some embodiments of the disclosed technology may improve the reliability of depth images by filtering out chips in which intensity is attenuated.

Reference will now be made in detail to some embodiments of the disclosed technology, examples of which are illustrated in the accompanying drawings. Wherever possible, the same reference numbers will be used throughout the drawings to refer to the same or like parts. While the disclosed technology is susceptible to various modifications and alternative forms, specific embodiments thereof are shown by way of example in the drawings. However, the disclosed technology should not be construed as being limited to the embodiments set forth herein.

Hereinafter, various embodiments will be described with reference to the accompanying drawings. However, it should be understood that the disclosed technology is not limited to specific embodiments, but includes various modifications, equivalents and/or alternatives of the embodiments. The embodiments of the disclosed technology may provide a variety of effects capable of being directly or indirectly recognized through the disclosed technology.

In a time-of-flight (TOF) sensor such as a light detection and ranging (LiDAR) sensor, a histogram represents the distribution of time or signal intensity with respect to distance information. The sensor emits multiple light signals (e.g., laser) over a certain period of time, and the arrival time of each reflected light signal is divided into time bins. Histogram count values represent how frequently reflected signals arrive within each time interval. Intensity attenuation (IA) issues in such a TOF sensor arises over time as the histogram count values decrease progressively. This leads to a decrease in the corresponding intensity code values of a generated intensity image (e.g., 2-D image generated based on histogram count values), resulting in degradation of sensing reliability.

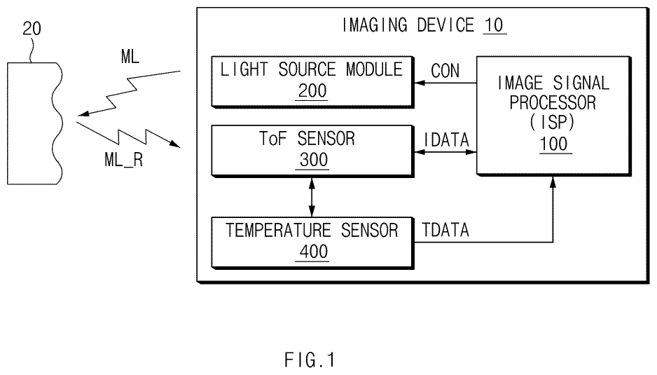

To address this issue, the disclosed technology can be implemented in some embodiments to provide an algorithm to detect the occurrence of IA in a TFO sensor utilizing single-photon avalanche diode (SPAD) pixels and time-to-digital converter (TDC) circuitry. In some embodiments, such an algorithm may include identifying chips (e.g., image sensor chips) with IA by (1) tracking intensity over a certain time period, (2) tracking temperature over the certain time period, (3) performing an intensity fluctuation check per time unit, and (4) performing a correlation analysis between temperature and intensity. In some implementations, in order to track intensity, a processor monitors the temporal changes in the representative intensity values of macro pixels that can fully receive laser signals (e.g., vertical-cavity surface-emitting laser, VCSEL) under normal conditions. In some implementations, in order to track temperature, the processor tracks the internal temperature of the TOF sensor over the same time period. In some implementations, the intensity fluctuation check can be performed as follows. From the average intensity values, the algorithm computes the maximum rate of intensity change per unit time. If the absolute value of the maximum rate of intensity change exceeds a predefined threshold, this suggests a potential IA issue. In some implementations, the correlation analysis between temperature and intensity can be performed as follows. The algorithm calculates the correlation coefficient between the temperature values and the average intensity values. In some implementations, if both of the following conditions are met: (1) the correlation coefficient between temperature and intensity is below the threshold; and (2) the maximum intensity change rate is above the threshold, then it can be determined that the chip has IA issues. FIG. 1 is a block diagram illustrating an example of an imaging device 10 based on some embodiments of the disclosed technology.

Referring to FIG. 1, the imaging device 10 maybe, for example, a digital still camera for photographing still images or a digital video camera for capturing moving images. For example, the imaging device 10 may be implemented as a Digital Single Lens Reflex (DSLR) camera, a mirrorless camera, a smartphone, and others. The imaging device 10 may include a device having both a lens and an image pickup element such that the device can capture a target object and generate an image of the target object.

The imaging device 10 may include an image signal processor 100, a light source module 200, a distance sensor such as a time-of-flight (TOF) sensor 300, and a temperature sensor 400.

The imaging device 10 may measure the distance to a target object 20 using the TOF (time of flight) principle that calculates the distance to the target object 20 based on the time it takes for light emitted by the imaging device 10 to be reflected from the target object 20 and then return to the imaging device 10.

The image signal processor 100 may process a generated image signal to perform noise cancellation and improve image quality. For example, the image signal processor 100 may process a depth image generated using the TOF sensor 300 to perform noise cancellation and improve image quality.

The depth image output from the image signal processor 100 may be stored in either the imaging device 10 or an internal or external memory of a device equipped with the imaging device 10 according to a user's request or through automation or may be displayed on a display according to a user's request or through automation. Alternatively, the depth image output from the image signal processor 100 may be used to control the operation of the imaging device 10 or the operation of the device equipped with the imaging device 10.

In addition, the image signal processor 100 may collect pixel data for each pixel (e.g., per-pixel pixel data) received from the TOF sensor 300, and may thus generate at least one of a depth image indicating the distance to the target object 20 or an intensity image.

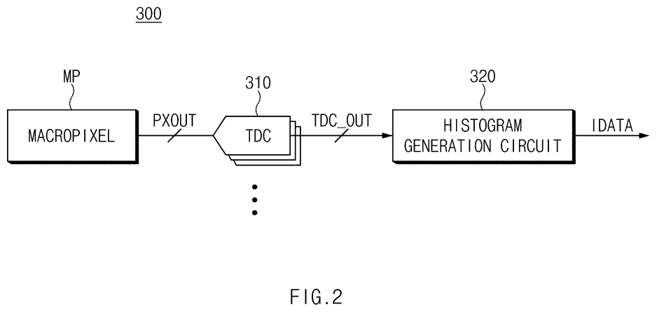

The image signal processor 100 based on the disclosed technology may determine whether intensity attenuation has occurred by analyzing changes in intensity values over time and changes in temperature over time. Constituent elements for analyzing intensity images and temperature changes, as well as the process for determining the occurrence or non-occurrence of intensity attenuation based on the result of this analysis, will be described in detail with reference to FIGS. 2 to 9.

A light source module 200 may emit modulated light (ML) to a target object 20 upon receiving a control signal from the image signal processor 100. The light source module 200 may be a laser diode (LD) or a light emitting diode (LED) for emitting light (e.g., infrared (IR) light or visible light) having a specific wavelength band, or may be any one of a Near Infrared Laser (NIR), a point light source, a monochromatic light source combined with a white lamp or a monochromator, and a combination of other laser sources. For example, the light source module 200 may emit infrared (IR) light having a wavelength of 800 nm to 1000 nm. In some embodiments, the following description will be given on the assumption that the light source module 200 emits infrared (IR) light. The modulated light (ML) may be pulse light modulated with predetermined modulation characteristics (e.g., waveform, wavelength, period, amplitude, frequency, phase, duty rate, etc.). In one example, the light source module 200 may include a vertical-cavity surface-emitting laser (VCSEL) light source. The VCSEL light source may correspond to a semiconductor laser diode that emits a laser in a direction perpendicular to the surface.

The TOF sensor 300 may include one or more photosensors to receive and detect reflected light from the target object 20 which reflects modulated light (ML) from the light source module 200 as shown in FIG. 1. This detection of reflected light from the targe object 20 by the TOF sensor 300 can be used to measure the distance to the target object 20 by measuring the time of light from the light to travel from the light source module 200 to the target object 20 and back to the TOF sensor 300 so that the distance to the target object 20 can be calculated or determined under the control of the image signal processor 100. In some embodiments, the TOF method may be implemented as a direct TOF method. The direct TOF method may directly measure a round-trip time from a first time where modulated light (ML) modulated with predetermined modulation characteristics is emitted to the target object 20 to a second time where reflected light (ML_R) reflected from the target object 20 is incident and detected, and may thus calculate the distance to the target object 20 by calculating the round-trip time and the speed of light.

The TOF sensor 300 may operate by receiving a control signal from the image signal processor 100. In some embodiment, the TOF sensor 300 may include multiple photosensors arranged in pixels for sensing reflected light from the target object 20. Adjacent pixels in the TOF sensor 300 may be grouped to form a macropixel (MP) for the TOF sensing of the distance. The TOF sensor 300 may provide pixel data generated in the process of calculating the distance to the target object 20 to the image signal processor 100. In addition, the TOF sensor 300 may transmit the result of measuring the distance to the target object 20 to the image signal processor 100. For example, the TOF sensor 300 may transmit the round-trip time of the modulated light (ML) and the reflected light (ML_R) to the image signal processor 100.

The temperature sensor 400 may detect the temperature of the TOF sensor 300 and provide the detected temperature data (TDATA) to the image signal processor 100. For example, the temperature sensor 400 may be located near a photosensor such as a macropixel (hereinafter referred to as “MP”) of the TOF sensor 300 that receives and detects reflected light (ML_R) from the target object 20. However, the installation location of the temperature sensor 400 within the image signal processor 100 is not limited to this example and may be adjusted as needed.

FIG. 2 is a block diagram illustrating the time-of-flight (TOF) sensor shown in FIG. 1 based on some embodiments of the disclosed technology.

Referring to FIG. 2, the TOF sensor 300 may include a macropixel (MP), a time-to-digital converter (hereinafter referred to as “TDC”) 310, and a histogram generation circuit 320. For example, the TOF sensor 300 may measure the time it takes for light to be reflected from a target object and returns to the sensor using a time-correlated single-photon counting (hereinafter referred to as “TCSPC”) method.

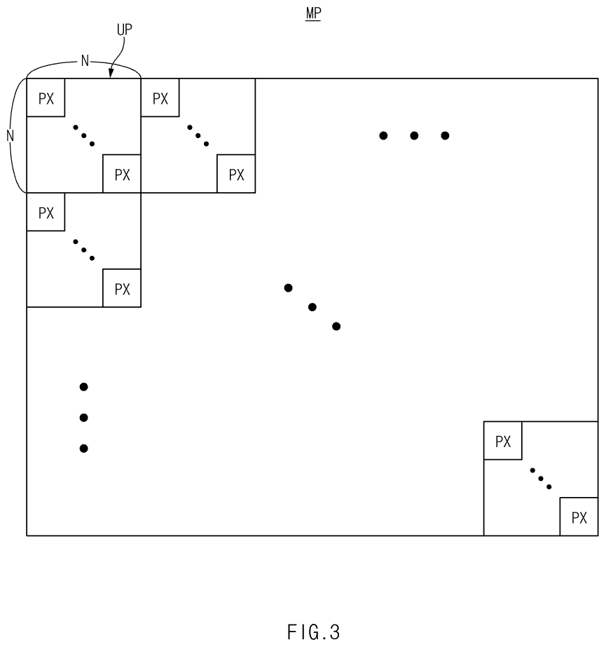

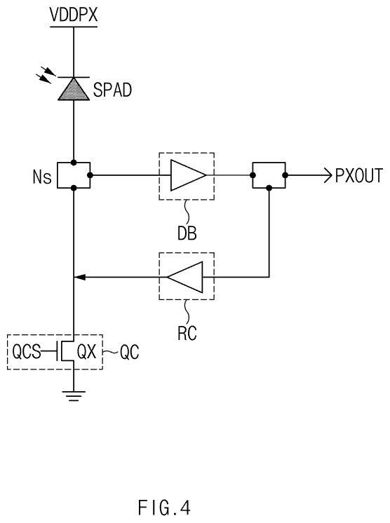

The macropixel (MP) may include a plurality of pixels (PXs) arranged in a row direction and a column direction to generate a pixel signal (PXOUT). In some implementations, a pulse signal of the pixel signal (PXOUT) generated by a macropixel (MP) may be referred to as a single-photon avalanche diode (SPAD) pulse. The detailed configuration and operation of the macropixel (MP) will be described later with reference to FIGS. 3 and 4.

The TDC 310 may calculate a time delay between a pulse of the pixel signal (PXOUT) output from the macropixel (MP) and a reference pulse of the modulated light (ML), and may convert the resultant pulse into a digital value corresponding to the time delay to generate TDC data (TDC_OUT).

For example, the TDC 310 may include digital logic configured to calculate a time delay between the pulse of the pixel signal (PXOUT) and the reference pulse to generate digital data, and an output buffer configured to store the generated digital data. The TDC 310 may collectively refer to the digital logic and the output buffer. The TDC 310 may be a converter configured to convert information about the arrival time of photons received by a plurality of SPAD elements (to be described later) into a digital signal. In some implementations, the TDC 310 may be a TDC block including a plurality of TDCs.

The histogram generation circuit 320 may collect photoelectric conversion amount data over time based on the TDC data (TDC_OUT), and may generate a histogram and image data (IDATA). Here, the histogram may correspond to a graph that accumulates pixel data or a photoelectric conversion amount generated by a single pixel over time to display the resultant data (e.g., resultant distribution). The histogram generation circuit 320 may accumulate and store timestamp data in time bins based on the TDC data (TDC_OUT), and may identify a bin having a peak value. Although the present example describes the histogram generation circuit 320 and the TDC 310 as separate components, other implementations are also possible. For example, the histogram generation circuit 320 may be integrated into the TDC 310 as needed.

FIG. 3 is a schematic diagram illustrating an example of a macropixel included in the time-of-flight (TOF) sensor shown in FIG. 2 based on some embodiments of the disclosed technology.

Referring to FIG. 3, the macropixel (MP) may include a plurality of pixels (PXs).

For example, (N×N) pixels (where “N” is a natural number greater than or equal to 2) may be grouped to form a unit pixel (UP). One macropixel (MP) may include a plurality of unit pixels (UPs) arranged in a matrix configuration.

For example, the macropixel (MP) may correspond to a group of pixels (PXs) in which pixels are arranged in a (24×24) or (12×12) matrix configuration. Although this example describes the macropixel (MP) as including (24×24) or (12×12) pixels (PXs) in the row direction and the column direction for convenience of description, other implementations are also possible, and the number of pixels constituting the macropixel is not limited thereto.

The plurality of pixels (PXs) may detect incident reflected light (ML_R) and generate a pixel signal (PXOUT). The pixels (PXs) may be grouped into a macropixel unit. Here, the pixels (PXs) may be one macropixel or a plurality of macropixels may be arranged in an array structure.

The following description is provided on the premise that each pixel (PX) is a single-photon avalanche diode (SPAD) pixel for detecting a distance to the target object 20 based on the direct time-of-flight (TOF) method. However, the scope of the disclosed technology is not limited thereto. The detailed configuration and operation of the pixel (PX) will be described later with reference to FIG. 4.

FIG. 4 is a circuit diagram illustrating an example of the pixel shown in FIG. 3 based on some embodiments of the disclosed technology.

Referring to FIG. 4, the pixel (PX) may include a single-photon avalanche diode (SPAD), a quenching circuit (QC), a digital buffer (DB), and a recharging circuit (RC).

The SPAD may detect a single photon of reflected light (RL) reflected from a target object 20, and may generate a current pulse corresponding to the detected single photon. The SPAD may operate as a photodiode including a photosensitive P-N junction. Since avalanche breakdown is triggered by a single photon incident in a Geiger mode in which a reverse bias voltage caused by a cathode-anode voltage exceeding a breakdown voltage occurs, the SPAD may generate a current pulse.

The Geiger mode may refer to the application of a reverse bias voltage greater than the breakdown voltage to the SPAD, enabling the detection of a single photon in the SPAD. In the Geiger mode, since the intensity of an electric field applied to an amplifying layer is strong enough even the absorption of a small number of photons triggers an avalanche current breakdown phenomenon, resulting in a large output current. This allows the detection of a single photon. Hereinafter, the process in which avalanche breakdown is triggered by a single photon and a voltage pulse is generated will be referred to as an avalanche process.

One terminal of the SPAD may receive a first bias voltage (VDDPX) for applying a reverse bias voltage (hereinafter referred to as an “operating voltage”) higher than the breakdown voltage to the SPAD. For example, the first bias voltage (VDDPX) may be a positive(+) voltage having an absolute value lower than the absolute value of the breakdown voltage. The other terminal of the SPAD may be connected to a sensing node (Ns), and the SPAD may output a current pulse generated by detecting a single photon to the sensing node (Ns).

Although the embodiment of the disclosed technology has disclosed that the SPAD is illustrated as a light receiving element (i.e., a light detection element) of the pixel (PX), the scope of the embodiment is not limited to the SPAD. That is, as a light receiving element of the pixel (PX), in addition to the SPAD, various elements operating in the Geiger mode, such as an avalanche photodiode (APD), a silicon photomultiplier (SiPM), and the like, can be used.

The quenching circuit (QC) may control the voltage of the SPAD. After a voltage pulse is generated due to avalanche breakdown and the voltage of the sensing node (Ns) changes, the quenching circuit (QC) may perform a quenching operation for returning the voltage of the sensing node (Ns) to the Geiger mode.

After the lapse of time during which the avalanche process can occur, the quenching transistor (QX) of the quenching circuit (QC) is turned on based on the quenching control signal (QCS) to electrically connect the sensing node (Ns) to the ground voltage. Accordingly, the reverse bias voltage applied to the SPAD is reduced below the breakdown voltage, and the avalanche process may be quenched (or stopped).

The digital buffer (DB) may sample an analog current pulse to be applied to the sensing node (Ns), and may convert the sampled analog current pulse into a digital pulse signal. The digital buffer (DB) may generate a pulse signal at a frequency based on a frequency of receiving photons. Here, the sampling method may be a method of converting a current pulse into a pulse signal having a logic level of 0 or 1 depending on whether the level of the current pulse is equal to or higher than a threshold level, but the scope of the disclosed technology is not limited thereto. Accordingly, the pulse signal output from the digital buffer (DB) may be transmitted as a direct pixel signal (PXOUT) to the TDC 310.

The recharging circuit (RC) may implant charges into the sensing node (Ns) to cause the SPAD to re-enter the Geiger mode which can induce avalanche breakdown after the avalanche process is quenched by the quenching circuit (QC).

For example, the recharging circuit (RC) may include a switch (e.g., a transistor) that can selectively connect a second bias voltage to the sensing node (Ns) based on a recharge control signal. When the switch is turned on, the voltage of the sensing node (Ns) may reach the second bias voltage.

For example, a sum of the absolute value of the second bias voltage and the absolute value of the first bias voltage (VDDPX) may be greater than an absolute value of the breakdown voltage, and the second bias voltage may be a negative(−) voltage. Accordingly, the SPAD may enter the Geiger mode and an avalanche process may proceed upon reception of a single photon at the next timing point.

Although the present embodiment has disclosed an example in which the quenching circuit (QC) and the recharging circuit (RC) are implemented as active devices for convenience of description, it should be noted that the quenching circuit (QC) and the recharging circuit (RC) may also be implemented as passive devices as needed. For example, the quenching transistor (QX) of the quenching circuit (QC) may also be replaced with a resistor.

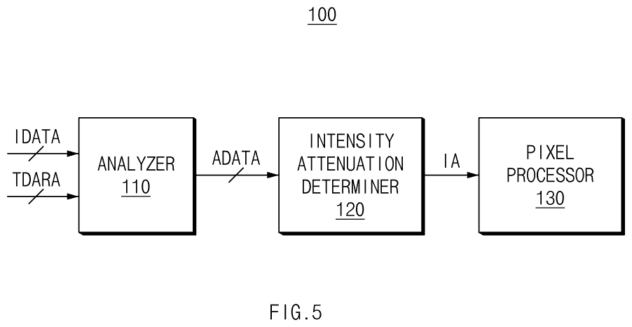

FIG. 5 is a block diagram illustrating an example of the image signal processor shown in FIG. 1 based on some embodiments of the disclosed technology.

Referring to FIG. 5, the image signal processor 100 may include an analyzer 110, an intensity attenuation determiner 120, and a pixel processor 130.

Here, the analyzer 110 may track changes in intensity values over time based on image data (IDATA) generated by collecting pixel data for each pixel received from the TOF sensor 300. In addition, the analyzer 110 may receive temperature data (TDATA) from the temperature sensor 400, and may track changes in temperature values over time. The analyzer 110 may track changes in intensity values over time and changes in temperature values over time, and may generate analysis data (ADATA).

In one embodiment, the analyzer 110 may track qualitative information related to intensity in the image data (IDATA). Here, the qualitative information may be a result of qualitative evaluation of the intensity, and may be information indicating whether intensity attenuation is reflected over time in an image captured by the TOF sensor 300. For example, the qualitative information may indicate the degree of intensity value reflected in the captured image.

In another embodiment, the analyzer 110 may track quantitative information related to intensity in the image data (IDATA). Here, the quantitative information may be a result of quantitative evaluation of the intensity, and may be information obtained by quantifying the intensity value that is attenuated over time in the image captured by the TOF sensor 300. For example, the quantitative information may be information obtained by quantifying the degree of attenuation of an intensity code reflected in the captured image.

The analyzer 110 may generate an intensity image based on the image data (IDATA) generated when each macropixel (MP) included in the TOF sensor 300 receives reflected light (ML_R). Here, the “intensity image” may be an image indicating the number of counts obtained when each macropixel (MP) included in the TOF sensor 300 receives reflected light (ML_R) and a single-photon avalanche diode (SPAD) reacts to the reflected light (ML_R). The expression “intensity” may indicate the number of counts of photons generated when the SPADs of the macropixels included in a target kernel receive reflected light (ML_R) and react to the reflected light (ML_R).

For example, for a specific period of time in the ON state of the light source, the analyzer 110 may accumulate and store intensity representative values based on the number of laser shots recognized by the SPAD included in the macropixel (MP), and may analyze the stored intensity representative values.

In some implementations, the analyzer 110 may analyze the deterioration order of macropixels (MPs) in the intensity image. For example, the analyzer 110 may determine a region of interest (ROI) from among the intensity image, and may analyze a situation in which the intensity representative value changes over time in a laser projection region where the ROI is set and laser is strongly projected. Here, the intensity representative value may represent an average value of the intensity in the ROI.

Reflected light (ML_R) reflected from the target object 20 may be projected in the form of dots through the TOF sensor 300 included in the imaging device 10. Here, the above-described “laser projection region” may represent a region projected in the form of dots on a pixel by the light source. In addition, the region of interest (ROI) may refer to a local region in which the TDC 310 is enabled or disabled. Each ROI for detecting some or all of the projected dots may be flexibly adjusted.

When a certain period of use elapses, the TOF sensor 300 may enable a histogram count value (i.e., the number of histogram counts) to be continuously reduced depending on a defect in the SPAD structure or a defect in the TDC 310 (or the histogram generation circuit 320). Furthermore, even if power supply is rebooted, the histogram generation operation may be performed from the decreased count value, and the degree of decrease in the count value may increase in proportion to the intensity of the light source. Since the intensity image is generated by summing the count values of the histogram, the intensity value may also decrease when the count values of the histogram decrease. As described above, the phenomenon in which the SPAD or the TDC 310 deteriorates and the intensity value decreases will hereinafter be defined as “intensity attenuation”.

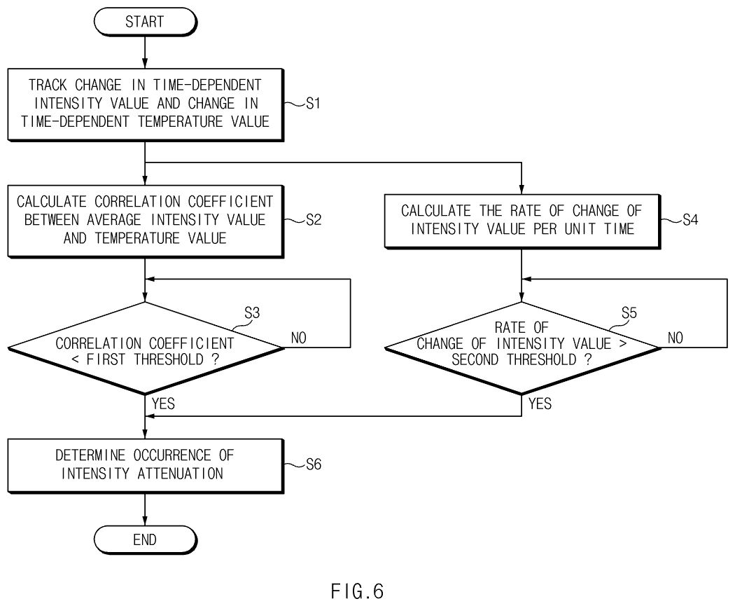

Accordingly, the analyzer 110 may set the average value of intensity (hereinafter referred to as “average intensity value”) and the temperature value as factors for determining whether the intensity is attenuated, and may analyze changes in intensity values (i.e., the change trend of intensity values). The operation of tracking and analyzing the intensity value over time by the analyzer 110 will be described in more detail with reference to FIGS. 6, 7A, 7B, 8A and 8B to be described later.

The intensity attenuation determiner 120 may determine whether the intensity of a macropixel (MP) is attenuated based on the analysis data (ADATA) received from the analyzer 110, and may generate attenuation data (IA) including information indicating occurrence of the intensity attenuation.

The intensity attenuation determiner 120 may compare the analysis data (ADATA) with a preset threshold value, and may generate attenuation data (IA) based on the comparison result. For example, the intensity attenuation determiner 120 may determine occurrence or non-occurrence of intensity attenuation using a correlation coefficient (first condition) and a rate of change of the intensity value per unit time (second condition). When both the first condition and the second condition are satisfied, the intensity attenuation determiner 120 may determine occurrence of the intensity attenuation.

The intensity attenuation determiner 120 may generate attenuation data (IA) through correlation analysis. The intensity attenuation determiner 120 may use a correlation coefficient to determine a linear correlation between the temperature value and the average value of the intensity values. For example, in some implementations, the Pearson correlation coefficient may be used. However, the Kendall correlation coefficient or the Spearman correlation coefficient may also be used as a correlation coefficient, and the scope of the correlation coefficient used to analyze such correlation is not limited thereto.

For example, the intensity attenuation determiner 120 may calculate a covariance of the temperature value and the average intensity value, and may calculate a correlation coefficient based on the calculated covariance. Here, the covariance may be defined as a value obtained by numerically representing a common part of the distribution of the average intensity value and the distribution of the temperature value. That is, the intensity attenuation determiner 120 may obtain the correlation coefficient by dividing the covariance value by a standard deviation of the temperature value and a standard deviation of the average intensity value.

When the correlation coefficient is less than a preset first threshold value, the intensity attenuation determiner 120 may determine that intensity attenuation has occurred. Here, the first threshold value may be experimentally determined in advance.

The intensity attenuation determiner 120 may calculate an absolute value (hereinafter referred to as a first value) of the rate of change of the intensity value per unit time, and may calculate a second value by dividing the first value by a maximum value of the intensity value. Here, the maximum value may refer to a value having the highest intensity code value in the region of interest (ROI) for determining the intensity attenuation. When the second value is higher than a preset second threshold value, the intensity attenuation determiner 120 may determine that intensity attenuation has occurred. Here, the second threshold value may be experimentally determined in advance.

In addition, the pixel processor 130 may deactivate a target macropixel in which the intensity attenuation has occurred based on the attenuation data (IA) received from the intensity attenuation determiner 120. Here, the target macropixel may correspond to a macropixel that is a target of determination as to whether or not the macropixel is an attenuation pixel (in which intensity attenuation has occurred), from among macropixels included in the TOF sensor 300.

For example, if the target macropixel (MP) is determined to be an intensity attenuation pixel (in which intensity attenuation has occurred), the imaging device 10 may not use pixel data of the target macropixel. Here, the operation of deactivating the target macropixel may be performed by a pixel corrector (not shown). The pixel corrector (not shown) may be included within the pixel processor 130, but is not limited thereto.

In another embodiment, the operations of analyzing the intensity image, determining occurrence or non-occurrence of intensity attenuation, and/or processing a macropixel in which intensity attenuation has occurred by the image signal processor 100 may be executed at module stages of the image signal processor 100. Accordingly, during a module test stage, among a plurality of modules including macropixels, a module including a macropixel (i.e., a dynamic dead macropixel DDMP) that is expected to have intensity attenuation after a certain period of time may be identified in advance. This allows for appropriate action to be taken with respect to this defective module.

In another embodiment, the operations of analyzing the intensity image, determining occurrence or non-occurrence of intensity attenuation, or processing a macropixel in which intensity attenuation has occurred by the image signal processor 100 may also be utilized in a wafer inspection stage.

As described above, in addition to detecting a macropixel in which intensity attenuation has occurred on each chip including the imaging device 10, a defect prevention (anti-defect) measure may also be taken based on the analysis result of intensity attenuation to reduce the likelihood of defective macropixels occurring in the future.

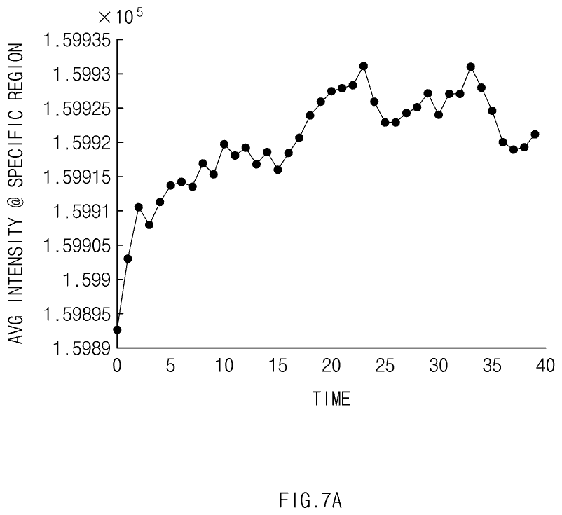

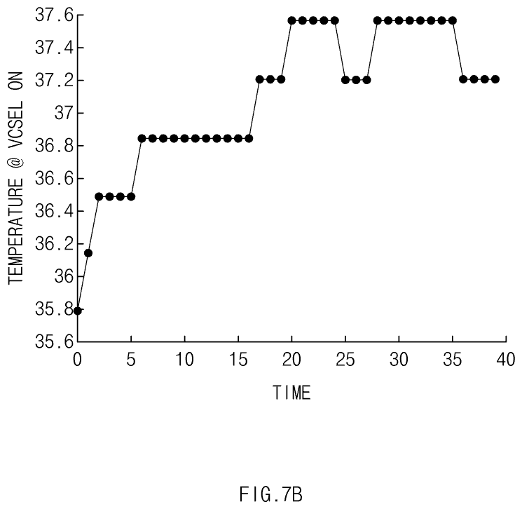

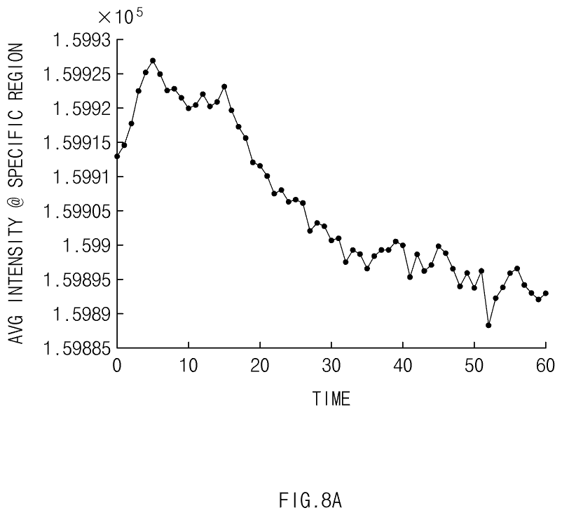

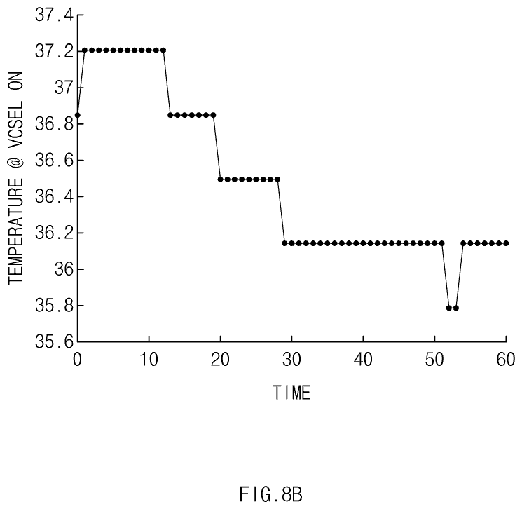

FIG. 6 is a flowchart illustrating example operations of the image signal processor shown in FIG. 5 based on some embodiments of the disclosed technology. FIGS. 7A and 7B are diagrams illustrating example graphs showing changes in intensity values and temperatures based on some embodiments of the disclosed technology. FIGS. 8A and 8B are diagrams illustrating example graphs showing changes in intensity values and temperatures based on other embodiments of the disclosed technology.

Referring to FIG. 6, the analyzer 110 may receive reflected light (ML_R) for each macropixel (MP) included in the TOF sensor 300, and may generate an intensity image based on the number of counts obtained by the SPAD reaction. The analyzer 110 may capture the intensity image for a predetermined time in a state in which the light source is turned on, and at the same time may track the changing intensity value. The analyzer 110 may analyze the temperature data (IDATA) received from the temperature sensor 400, and may track changes in temperature value over time (Operation S1).

The analyzer 110 may generate intensity data by analyzing the trend of changes in the intensity values of selected pixels in the intensity image captured at each time point (e.g., at specific intervals). For example, the analyzer 110 may extract an average value of the intensity values of the selected pixels (e.g., pixels having the top few percent intensity values) in order to analyze the trend of intensity values of the selected pixels over time within the intensity image. Here, “selected pixels” may refer to those pixels with the highest intensity codes (e.g., the top few percent) within the entire intensity image.

The analyzer 110 may analyze a pattern of changes in the average intensity value over time and a pattern of changes in the temperature value over time. As shown in the graph of FIG. 7A, the average intensity value in the ROI (region of interest) where laser is strongly projected, tends to increase overall over time. As shown in the graph of FIG. 7B, the temperature value also shows an overall upward trend over time when the light source is radiated.

Likewise, as shown in the graph of FIG. 8A, the average intensity value in the ROI (region of interest) where the laser is strongly projected, shows a pattern of overall decrease over time. As shown in the graph of FIG. 8B, the temperature value also shows a pattern of overall decrease over time when the light source is radiated. For example, FIGS. 8A and 8B represent graphs depicted when the power supply is first turned off and is then rebooted with turned-on power.

That is, referring to the graphs of FIGS. 7A and 7B, the pattern of changes in the average intensity value over time may be similar to the pattern of changes in the temperature value over time. Referring to FIGS. 8A and 8B, the pattern of changes in the average intensity value and the pattern of changes the temperature value over time may be similar to each other even when the power supply is rebooted.

The graphs illustrated in FIGS. 7A to 8B are merely examples for convenience of description, and waveforms, times, numbers, etc. of the graphs illustrated in FIGS. 7A to 8B may vary significantly depending on the analysis results of the analyzer 110, without being limited thereto.

Accordingly, the intensity attenuation determiner 120 may calculate a correlation coefficient between the average intensity value and the temperature value, and may determine the calculated correlation coefficient as the first condition for determining occurrence or non-occurrence of the intensity attenuation (Operation S2). The intensity attenuation determiner 120 may determine occurrence or non-occurrence of intensity attenuation by comparing the correlation coefficient with a preset first threshold value (Operation S3).

For example, when the correlation coefficient is less than the first threshold value, the intensity attenuation determiner 120 may determine occurrence of the intensity attenuation. On the other hand, when the correlation coefficient is equal to or higher than the first threshold value, the intensity attenuation determiner 120 may determine the corresponding pixel to be a normal pixel having no intensity attenuation.

The intensity attenuation determiner 120 may calculate the rate of change of the intensity value per unit time, and may determine the calculated change rate to be a second condition for determining occurrence or non-occurrence of the intensity attenuation (Operation S4). That is, the intensity attenuation determiner 120 may convert the change of the intensity value per unit time into an absolute ratio of the maximum intensity value. The intensity attenuation determiner 120 may compare the rate of change of the intensity value with a preset second threshold value, and may determine occurrence or non-occurrence of the intensity attenuation based on the result of comparison (Operation S5).

For example, when the rate of change in the intensity value is greater than the preset second threshold value, the intensity attenuation determiner 120 may determine occurrence of intensity attenuation.

That is, the intensity attenuation determiner 120 may determine that intensity attenuation has occurred, when there is a significant difference between the intensity value of the normal macropixel and the intensity value of the macropixel where intensity attenuation has occurred. On the other hand, when the rate of change in the intensity value is less than the second threshold value, the intensity attenuation determiner 120 may determine that the pixel is a normal pixel where intensity attenuation has not occurred.

The intensity attenuation determiner 120 may determine whether intensity attenuation has occurred according to the first condition, or may determine whether intensity attenuation has occurred based on the second condition.

In some embodiments of the disclosed technology, when the intensity attenuation determiner 120 satisfies both the first condition and the second condition, it may be determined that intensity attenuation has occurred (Operation S6). For example, the intensity attenuation determiner 120 may determine that intensity attenuation is the greatest when the average intensity value increases most steeply after the same amount of time has elapsed. In other words, it can be seen that the chip having the greatest intensity attenuation is more deteriorated in terms of reliability.

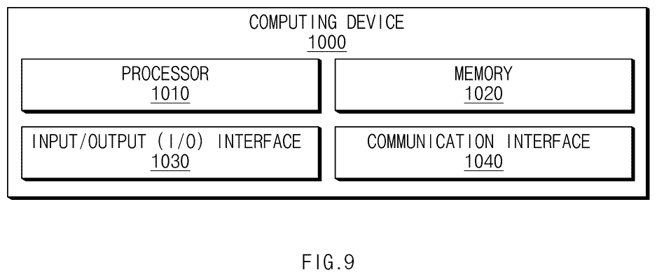

FIG. 9 is a block diagram showing an example of a computing device 1000 corresponding to the image signal processor 100 of FIG. 1.

Referring to FIG. 9, the computing device 1000 may represent an embodiment of a hardware configuration for performing the operation of the image signal processor 100 of FIG. 1.

The computing device 1000 may be mounted on a chip that is independent from the chip on which the time of flight (TOF) sensor is mounted. In one embodiment, the chip on which the time of flight (TOF) sensor is mounted and the chip on which the computing device 1000 is mounted may be implemented in one package, for example, a multi-chip package (MCP), but the scope of the disclosed technology is not limited thereto.

The computing device 1000 may include a processor 1010, a memory 1020, an input/output (I/O) interface 1030, and a communication interface 1040.

The processor 1010 may process data and/or instructions required to perform the operations of the components (110, 120, 130) of the image signal processor 100 described in FIG. 1. That is, the processor 1010 may refer to the image signal processor 100, but the scope of the disclosed technology is not limited thereto.

The memory 1020 may store data and/or instructions required to perform operations of the components (110, 120, 130) of the image signal processor 100, and may be accessed by the processor 1010. For example, the memory 1020 may be volatile memory (e.g., Dynamic Random Access Memory (DRAM), Static Random Access Memory (SRAM), etc.) or non-volatile memory (e.g., Programmable Read Only Memory (PROM), Erasable PROM (EPROM), EEPROM (Electrically Erasable PROM), flash memory, etc.).

That is, the computer program for performing the operations of the image signal processor 100 disclosed in this document is recorded in the memory 1020 and executed and processed by the processor 1010, thereby implementing the operations of the image signal processor 100.

The input/output (I/O) interface 1030 is an interface that connects an external input device (e.g., keyboard, mouse, touch panel, etc.) and/or an external output device (e.g., display) to the processor 1010 to allow data to be transmitted and received.

The communication interface 1040 is a component that can transmit and receive various data with an external device (e.g., an application processor, external memory, etc.), and may be a device that supports wired or wireless communication.

As is apparent from the above description, the image signal processor and the imaging device including the same based on some embodiments of the disclosed technology may increase the reliability of depth images by filtering a chip in which intensity is attenuated.

The embodiments of the disclosed technology may provide a variety of effects capable of being directly or indirectly recognized through the above-mentioned patent document.

Although a number of illustrative embodiments have been described, it should be understood that modifications and enhancements to the disclosed embodiments and other embodiments can be devised based on what is described and/or illustrated in this patent document. Therefore, the scope of the disclosed technology should not be limited to the above-described embodiments but should include the equivalents thereof.

What is claimed is:

1. An imaging device, comprising:
an image signal processor which includes:
an analyzer configured to: generate an intensity image of an object to be imaged by an image sensor based on a count value representing a number of detection events obtained by sensing reflected light from the object and detecting photons of the reflected light; analyze a change in an intensity value of the intensity image over a first time period; and analyze a change in a temperature over the first time period; and
an intensity attenuation determiner configured to determine an occurrence of intensity attenuation in the intensity image over time based on an analysis result of the analyzer.

2. The imaging device according to claim 1, further comprising:
at least one macropixel that includes a single-photon avalanche diode (SPAD) element for sensing reflected light from the object and detecting photons of the reflected light.

3. The imaging device according to claim 1, further comprising:
at least one macropixel that includes a plurality of pixels arranged in a matrix configuration for sensing the reflected light,
wherein
the plurality of pixels is grouped into a predetermined number of pixel groups to form a unit pixel.

4. The imaging device according to claim 1, wherein the analyzer is configured to:
determine a region of interest (ROI) in the intensity image; and
analyze an average intensity value of a region within the ROI where light is projected above a predetermined threshold value.

5. The imaging device according to claim 1, wherein the analyzer is configured to:
capture the intensity image over a predetermined time period; and
analyze a trend of changes over time in average intensity values of selected pixels in the intensity image captured at each time point.

6. The imaging device according to claim 5, wherein:
the selected pixels are pixels with intensity values corresponding to a predetermined number of highest intensity codes in the intensity image.

7. The imaging device according to claim 1, wherein the intensity attenuation determiner is configured to:
determine the occurrence of intensity attenuation using a correlation coefficient between the temperature value and an average intensity value.

8. The imaging device according to claim 7, wherein the intensity attenuation determiner is configured to:
calculate a covariance between the average intensity value and the temperature value; and
calculate the correlation coefficient by dividing the calculated covariance by a standard deviation of the temperature value and the average intensity value.

9. The imaging device according to claim 7, wherein the intensity attenuation determiner is configured to:
determine the occurrence of intensity attenuation in response to the correlation coefficient being less than a preset first threshold value.

10. The imaging device according to claim 1, wherein the intensity attenuation determiner is configured to:
perform a conversion by converting a change in the intensity value per unit time into an absolute ratio of a maximum intensity value to determine the occurrence of intensity attenuation.

11. The imaging device according to claim 10, wherein the conversion includes:
calculating an absolute value for a rate of the change of the intensity value per unit time; and
determining a first value by dividing the absolute value by the maximum intensity value.

12. The imaging device according to claim 11, wherein the intensity attenuation determiner is configured to:
determine the occurrence of intensity attenuation in response to the first value being higher than a preset second threshold value.

13. The imaging device according to claim 12, further comprising:
a pixel processor configured to deactivate a macropixel identified by the intensity attenuation determiner as having experienced the intensity attenuation.

14. An imaging device comprising:
a light source module configured to emit modulated light toward a target object;
a time-of-flight (TOF) sensor including a pixel configured to generate pixel data in response to detecting reflected light reflected from the target object;
a temperature sensor configured to generate a temperature value corresponding to a temperature of the time-of-flight (TOF) sensor; and
an image signal processor configured to: generate an intensity image based on a count value representing a number of detection events the pixel detects photons of the reflected light; analyze a change in an intensity value of the intensity image over a first time period; analyze a change in the temperature value over the first time period; and determine an occurrence of intensity attenuation of the pixel.

15. The imaging device according to claim 14, wherein the time-of-flight (TOF) sensor includes:
a time-to-digital converter (TDC) configured to convert, into a digital signal, information about a time it takes for the reflected light to reach the time-of-flight (TOF) sensor; and
a histogram generation circuit configured to generate a histogram based on the digital signal.

16. The imaging device according to claim 14, wherein:
the pixel in the TOF sensor includes a single-photon avalanche diode (SPAD) element.

17. The imaging device according to claim 14, wherein the image signal processor is configured to:
determine the occurrence of intensity attenuation using a correlation coefficient between the temperature value and an average intensity value.

18. The imaging device according to claim 17, wherein the image signal processor is configured to:
determine the occurrence of intensity attenuation in response to the correlation coefficient being less than a preset first threshold value.

19. The imaging device according to claim 14, wherein the image signal processor is configured to:
determining a first value by converting a change in the intensity value per unit time into an absolute ratio of a maximum intensity value to determine the occurrence of intensity attenuation.

20. The imaging device according to claim 19, wherein the image signal processor is configured to:
determine the occurrence of intensity attenuation in response to the first value being higher than a preset second threshold value.
